(19) United States
(12) Patent Application Publication
(10) Pub. No.: US 2015/0024262 A1
(43) Pub. Date: Jan. 22, 2015

(54) RECHARGEABLE BATTERY

(71) Applicant: Samsung SDI Co., Ltd., Yongin-si (KR)

(72) Inventor: Yu-Sik Hwang, Yongin-si (KR)

(73) Assignee: Samsung SDI Co., Ltd., Yongin-si (KR)

(21) Appl. No.: 14/157,362

(22) Filed: Jan. 16, 2014

(30) Foreign Application Priority Data
Jul. 17, 2013 (KR) 10-2013-0084373

(51) Int. Cl. H01M 2/04; H01M 2/30

(52) U.S. Cl. CPC H01M 2/0404; H01M 2/302
USPC 429/181

(57) ABSTRACT

A rechargeable battery is disclosed. In one aspect, the rechargeable battery includes an electrode assembly including a first electrode plate, a second electrode plate, and a separator interposed between the first and second electrode plates. The rechargeable battery also includes an electrolyte and a can having an opening which is formed at the top of the can and through which the electrode assembly is inserted, the can accommodating the electrode assembly and the electrolyte. The rechargeable battery further includes a cap plate sealing the opening of the can, attached to the can and forming a recessed region and a protrusion region protruding along a first direction toward the top of the can so as to form a step with respect to the recessed region, a protective circuit module disposed on the cap plate, and an electrode terminal formed on the cap plate.

### CROSS-REFERENCE TO RELATED APPLICATIONS

This application claims the benefit of Korean Patent Application No. 10-2013-0084373, filed on Jul. 17, 2013, in the Korean Intellectual Property Office, the disclosure of which is incorporated herein in its entirety by reference.

### BACKGROUND

1. Field

The described technology generally relates to a rechargeable battery.

2. Description of the Related Technology

As the wireless Internet and communication technology develops, electronic devices such as mobile phones or portable computers that can operate using a rechargeable battery without being connected to a power supply device are rapidly propagating. Generally, mobile phones or portable computers are small and convenient to carry, and thus have excellent mobility. Therefore, mobile phones and portable computers have been widely adopted in business and personal domains.

Due to the above-described portability of electronic devices, the demand for miniaturization, thin packaging and high-power capacity rechargeable batteries is gradually increasing. Consequently, various technologies have been developed to satisfy this demand. However, when designing to achieve high-power, for example, by improved energy density, it is generally difficult to achieve miniaturization and thinness, since there are limitations in improvements to energy density.

### SUMMARY OF CERTAIN INVENTIVE ASPECTS

One inventive aspect is a rechargeable battery, and more particularly, a structure of the rechargeable battery which enables the rechargeable battery to achieve miniaturization/slimming and an improved energy density.

Another aspect is a rechargeable battery including an electrode assembly including a first electrode plate having a first polarity, a second electrode plate having a second polarity, and a separator interposed between the first and second electrode plates, an electrolyte, a can having an opening which is formed at the top of the can through which the electrode assembly is inserted, the can housing the electrode assembly and the electrolyte, a cap plate sealing the opening of the can, attached to the can and forming a recessed region and a protrusion region protruding in a first direction toward the top of the can so as to form a step with respect to the recessed region, a protective circuit module disposed on the cap plate, and an electrode terminal formed on the cap plate.

The electrode terminal may be disposed in the recessed region.

The electrode terminal may be disposed at one side of the recessed region adjacent to the protrusion region.

The protective circuit module may be disposed in the recessed region.

The protective circuit module may further include a first lead plate and a second lead plate electrically connecting the protective circuit module to the electrode terminal and the cap plate.

The first lead plate may electrically connect the protective circuit module to the electrode terminal, and the second lead plate may electrically connect the protective circuit module to a region of the cap plate disposed at a distance from the electrode terminal in the recessed region.

The top of the electrode assembly may have a shape in which a portion of the top of the electrode assembly is recessed and the remaining portion of the top of the electrode assembly protrudes, corresponding to the recessed region and the protrusion region.

The rechargeable battery may further include an insulation member interposed between the electrode assembly and the cap plate and electrically insulating the electrode assembly from the cap plate.

The electrode assembly may include a first electrode tab and a second electrode tab that extend in the first direction, and the first electrode plate may be electrically coupled to the electrode terminal via the first electrode tab, and the second electrode plate may be electrically coupled to the cap plate via the second electrode tab.

The height of the protective circuit module may be substantially equal to or less than the height of the step formed by the protrusion region and the recessed region.

The can may include a bottom surface and a plurality of side surfaces that are substantially perpendicular to the bottom surface, lower portions of the plurality of side surfaces being connected to the bottom surface and upper portions of the side surfaces forming the opening, and the cap plate may be attached to the upper parts of the side surfaces and may include a recessed surface forming the recessed region and a protruding surface forming the protrusion region.

The rechargeable battery may further include a gasket interposed between the electrode terminal and the cap plate and electrically insulating the electrode terminal from the cap plate.

Another aspect is a rechargeable battery including an electrode assembly including a first electrode plate having a first polarity, a second electrode plate having a second polarity, and a separator interposed between the first and second electrode plates, an electrolyte, a case in which the electrode assembly and the electrolyte are accommodated, the top of which includes a recessed region and a protrusion region protruding in a first direction toward the top of the case so as to form a step with respect to the recessed region, a protective circuit module disposed on the top of the case, and an electrode terminal formed on the top of the case.

The electrode terminal may be disposed in the recessed region.

The protective circuit module may be disposed in the recessed region.

The protective circuit module may further include a first lead plate and a second lead plate provided at respective sides of the protective circuit module, wherein the first lead plate electrically connects the protective circuit module to the electrode terminal, and the second lead plate electrically connects the protective circuit module to a region of the case disposed at a distance from the electrode terminal in the recessed region.

The top of the electrode assembly may have a similar shape to the top of the case.

The rechargeable battery may further include a gasket interposed between the electrode terminal and the case and electrically insulating the electrode terminal from the case.

The electrode assembly may include a first electrode tab and a second electrode tab that extend in the first direction, and the first electrode plate may be electrically coupled to the electrode terminal via the first electrode tab, and the second electrode plate may be electrically coupled to the case via the second electrode tab.

The height of the protective circuit module may be substantially equal to or less than the height of the step formed by the protrusion region and the recessed region.

### BRIEF DESCRIPTION OF THE DRAWINGS

These and/or other aspects will become apparent and more readily appreciated from the following description of embodiments, taken in conjunction with the accompanying drawings.

FIG. 1 is an exploded perspective view schematically illustrating a rechargeable battery according to an embodiment

FIG. 2 is a cross-sectional view taken along line II-II of FIG. 1.

FIG. 3 is an excerpt side view illustrating a case and a protective circuit module of FIG. 1.

FIG. 4 is a side view illustrating a state in which the protective circuit module of FIG. 3 is disposed on the case.

### DETAILED DESCRIPTION OF CERTAIN INVENTIVE EMBODIMENTS

Reference will now be made in detail to embodiments, examples of which are illustrated in the accompanying drawings. In this regard, the present embodiments may have different forms and should not be construed as being limited to the descriptions set forth herein. Accordingly, the embodiments are merely described below, by referring to the figures, to explain aspects of the described technology. However, this is not intended to limit the described technology to particular modes of practice, and it is to be appreciated that all changes, equivalents, and substitutes that do not depart from the spirit and technical scope of the described technology are encompassed in the described technology. In the description, certain detailed explanations of related art are omitted when it is deemed that they may unnecessarily obscure the essence of the described technology. While such terms as “first,” “second,” etc., may be used to describe various components, such components must not be limited by these terms. The above terms are used only to distinguish one component from another. The terms used in the present specification are merely used to describe particular embodiments, and are not intended to limit the described technology. An expression used in the singular encompasses the expression of the plural, unless the context clearly indicated otherwise. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In the drawings, the thicknesses of several layers and regions may be exaggerated so as to clearly express the layers and the regions. Like reference numerals are used for like elements through the specification. It will be understood that when an element is referred to as being “on” another element, it can be directly on the other element or intervening elements may be present therebetween.

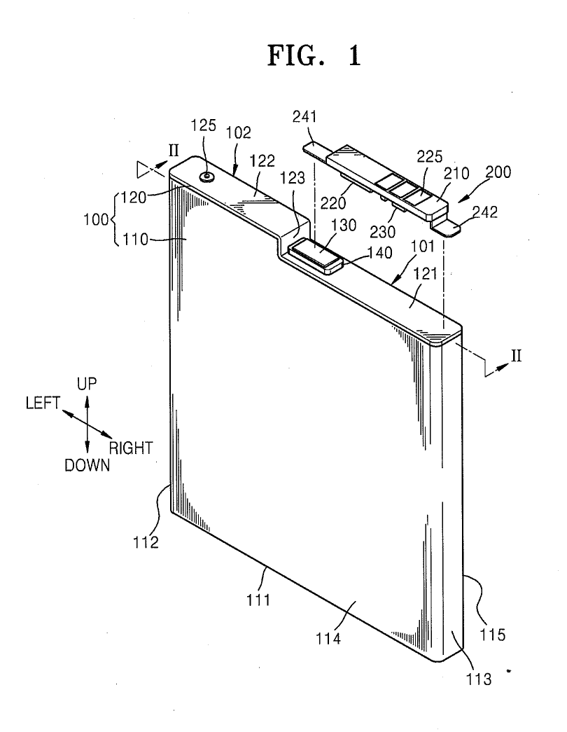

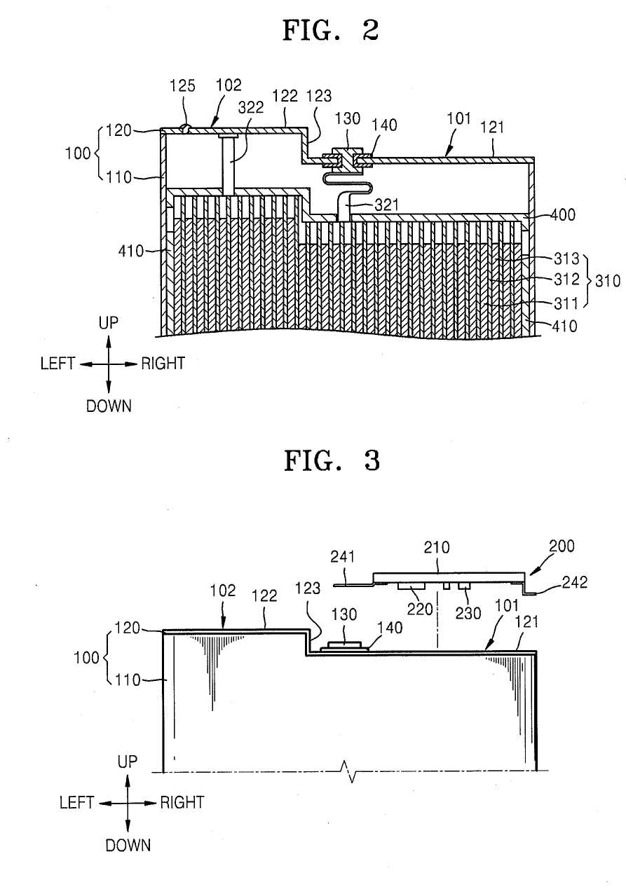

FIG. 1 is an exploded perspective view schematically illustrating a rechargeable battery according to an embodiment, and FIG. 2 is a cross-sectional view taken along line II-II of FIG. 1.

Referring to FIGS. 1 and 2, the rechargeable battery includes an electrode assembly 310, a case 100 in which an electrolyte (not shown) and the electrode assembly 310 are accommodated (or housed), an electrode terminal 130, and a protective circuit module 200. The case 100 includes a recessed region 101 and a protrusion region 102 which is formed protruding from the top of the case 100.

Referring to FIG. 1, the case 100 includes a can 110 having an opening through which the electrode assembly 310 is inserted into the case 100, and a cap plate 120 that seals the opening of the can 110.

The can 110 may have a substantially hexahedral shape in which one surface of the can 110, i.e., a surface corresponding to the top of the can 110 is opened. However, the can 110 may have other shapes according to the design requirements of the rechargeable battery. The can 110 may be manufactured of a metal material providing the strength of the can 110. The can 110 includes a bottom surface 111 positioned opposite to the top of the can 110 and four side surfaces 112, 113, 114, and 115 that are substantially perpendicular to the bottom surface 111. The first and second side surfaces 112 and 113 are disposed to face each other in a substantially parallel state, and the third and four side surfaces 114 and 115 are disposed to face each other in a substantially parallel state.

In order to form the recessed region 101 and the protrusion region 102 at the top of the case 100, the first and second side surfaces 112 and 113 may be formed with different heights. Portions of the third and four side surfaces 114 and 115 may extend further in an upward direction (hereinafter, referred to as a first direction) than the remaining portions thereof. For example, since the first side surface 112 is disposed adjacent to the protrusion region 102 and the second side surface 113 is disposed adjacent to the recessed region 101, the height of the first side surface 112 is greater than the height of the second side surface 113. Similarly, the portions of the third and fourth side surfaces 114 and 115 which are adjacent to the protrusion region 102 of the case 100, are higher than the portions of the third and the fourth side surfaces 114 and 115 which are adjacent to the recessed region 101.

In some embodiments, the cap plate 120 has two bent portions to form a stepped region and is attached to the top of the can 110 so as to seal the opening of the can 110. For example, the cap plate 120 includes a recessed surface (or a lower region) 121 that is a relatively low surface and a protruding surface (or a higher region) 122 that is a relatively high surface so as to form the step. The recessed surface 121 and the protruding surface 122 are integrally connected to each other by a connection surface (or a coupling portion) 123 that extends in the first direction. The cap plate 120 can be attached to the can 110 by a method such as welding and thus the recessed region 101 and the protrusion region 102 of the case 100 may be formed.

An electrolyte injection hole may be provided in the cap plate 120. After the cap plate 120 and the can 110 have been integrally attached to each other, the electrolyte is injected through the electrolyte injection hole, and the electrolyte injection hole is sealed with a stopper 125.

The electrode terminal 130 is formed on the cap plate 120. The electrode terminal 130 may be disposed in the recessed region 101 of the case 100, for example, on the recessed surface 121 of the cap plate 120. In this case, the electrode terminal 130 may be disposed adjacent to the protrusion region 102, i.e., at a side of the recessed surface 121 adjacent to the protruding surface 122 of the cap plate 120. The top surface of the electrode terminal 130 is exposed to the environment through the top surface of the cap plate 120, and the bottom of the electrode terminal 130 penetrates the cap plate 120 and extends to the inside of the can 110.

The cap plate 120 may be manufactured of a metal material, like that forming the can 110. As illustrated in FIG. 2, the electrode terminal 130 may be electrically coupled to a first electrode plate 311 of the electrode assembly 310 via a first electrode tab 321, and the cap plate 120 may be electrically coupled to a second electrode plate 313 of the electrode assembly 310 via a second electrode tab 322. Through this electrical coupling, the electrode terminal 130 may serve as a negative electrode of the rechargeable battery, and the cap plate 120 may serve as a positive electrode of the rechargeable battery. In this case, a gasket 140, formed of an electrically insulating material, may be disposed between the cap plate 120 and the electrode terminal 130 so as to prevent a short circuit therebetween. In the present embodiment, the electrode terminal 130 is the negative electrode, and the cap plate 120 is the positive electrode; however, according to embodiments, the electrode terminal 130 may be the positive electrode, and the cap plate 120 may be the negative electrode.

Referring to FIG. 2, the top of the electrode assembly 310 may have a similar shape to the shape of the case 100. For example, the top of the electrode assembly 310 may also have a stepped shape similar to the step of the cap plate 120. The top of the electrode assembly 310 may have a shape in which a portion of the top of the electrode assembly 310 corresponding to the recessed region 101 is recessed and the other portion of the top of the electrode assembly 310 corresponding to the protrusion region 102 protrudes.

The electrode assembly 310 may include the first electrode plate 311 and the second electrode plate 313 that are respectively coated with an electrode active material, and a separator 312 interposed between the first and second electrode plates 311 and 313. The electrode assembly 310 may be manufactured by forming a stacked structure in which the first electrode plate 311, the separator 312 and the second electrode plate 313 are sequentially stacked and then the stacked structure is wound to form a jelly roll. In the present embodiment, the electrode assembly 310 has a jelly roll shape, however, the described technology is not limited thereto. According to embodiments, the electrode assembly 310 may have a stacked structure in which the first electrode plate 311, the second electrode plate 313 and the separator 312 interposed therebetween are stacked.

Each of the first and second electrode plates 311 and 313 is respectively electrically coupled to the first electrode tab 321 and the second electrode tab 322 which transfer charge formed by a chemical reaction to the positive and negative electrodes.

The first and second electrode tabs 321 and 322 may extend in substantially the same direction. For example, the first and second electrode tabs 321 and 322 may extend in the first direction toward the top of the case 100.

The first electrode tab 321 extends in the first direction from the recessed portion of the electrode assembly 310 corresponding to the recessed region 101 of the case 100 and electrically connects the electrode terminal 130 to the first electrode plate 311. The second electrode tab 322 extends in the first direction from the protruding part of the electrode assembly 310 corresponding to the protrusion region 102 of the case 100 and electrically connects the cap plate 120 to the second electrode plate 313.

An insulation member 400 may be disposed in the can 110 and may be placed on the top of the electrode assembly 310. The insulation member 400 may electrically insulate the electrode assembly 310 from the cap plate 120 and may regulate the movement of the electrode assembly 310 in the can 110. The insulation member 400 may include through holes through which the first and second electrode tabs 321 and 322 may extend in the first direction.

In order to substantially prevent an electrical short circuit between the electrode assembly 310 and an inner wall of the can 110 and to suppress the movement of the electrode assembly 310, an insulation sheet 410 may be wound around the electrode assembly 310 prior to housing the electrode assembly 310 inside the case 100.

The protective circuit module 200 is disposed on the top of the case 100 and is electrically coupled to the electrode terminal 130 and the cap plate 120 via first and second lead plates 241 and 242. Since the protective circuit module 200 is placed in the recessed region 101 of the case 100, e.g., on the recessed surface 121 of the cap plate 120, the space efficiency of the rechargeable battery can be increased.

The protective circuit module 200 includes a substrate 210, a protective element 220 and a safety element 230 that are mounted on the substrate 210, and an external terminal 225 formed on the top surface of the substrate 210 so as to be electrically coupled to an external electronic device.

The horizontal length of the substrate 210 may be less than the horizontal lengths of the recessed region 101 and the recessed surface 121. The protective element 220 may be electrically connected to wiring patterns formed on the substrate 210 and may form a charging/discharging current path. The protective element 220 may be manufactured as one chip and may be mounted on the substrate 210.

The safety element 230, which is a secondary element, regulates or cuts off a charging/discharging current when a malfunction such as overheating or overcurrent occurs. The safety element 230 may include a positive temperature coefficient (PTC), a fuse, a current cutoff element, and a bi-metal. The protective element 220 and the safety element 230 may be mounted on the bottom surface of the substrate 210 so as to improve space efficiency. Alternatively, the protective element 220 and the safety element 230 may be embedded in the substrate 210.

The first and second lead plates 241 and 242 are provided at both sides of the protective circuit module 200. The first lead plate 241 contacts the electrode terminal 130 so as to form an electrical connection between the protective circuit module 200 and the electrode terminal 130. The second lead plate 242 contacts a region of the cap plate 120 so as to form an electrical connection between the protective circuit module 200 and the cap plate 120. In this case, the second lead plate 242 may contact a region of the recessed surface 121 of the cap plate 120 and may be welded to the region, i.e. a contact point disposed at a distance far from the electrode terminal 130.

According to some embodiments, the electrode terminal 130 is placed on the recesses surface 121 at a distance far from the protrusion region 102. In these embodiments, the first lead plate 241 is electrically connected to the electrode terminal. The second lead plate 242 can be electrically connected to the cap plate 120 at a region of the recessed surface 121 adjacent to the protrusion region 102, for example, at a side of the recessed surface 121 adjacent to the protruding surface 122 of the cap plate 120. Thus, the region where the second lead plate 242 is electrically connected to the cap plate 120 is far from the electrode terminal 130.

According to at least one of the above-described embodiments, the energy density of the rechargeable battery can be improved since the electrolyte and the electrode assembly 310 may be accommodated in an internal space enlarged by the protrusion region 102 of the case 100.

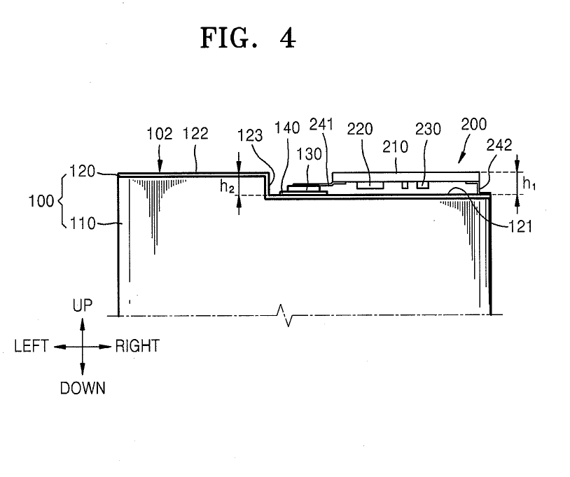

Also, according to at least one embodiment, the protective circuit module 200 is disposed in the recessed region 101 of the case 100 so that space efficiency thereof can be increased. Detailed descriptions thereof will be provided below with reference to FIGS. 3 and 4.

FIG. 3 is an excerpt side view illustrating the case 100 and the protective circuit module 200 of FIG. 1, and FIG. 4 is a side view illustrating a state in which the protective circuit module 200 of FIG. 3 is disposed on the case 100.

Referring to FIGS. 3 and 4, the protective circuit module 200 is disposed in the recessed region 101 of the case 100. For example, the protective circuit module 200 may be electrically coupled to the electrode terminal 130 and the recessed surface 121 of the cap plate 120 via the first and second lead plates 241 and 242.

The overall height h₁ of the protective circuit module 200 may be substantially equal to or less than the height h₂ of the step formed by the protruding surface 122 and the recessed surface 121 of the cap plate 120. Thus, the top surface of the protective circuit module 200 may be placed at a position that is substantially equal to or lower than the height of the protruding surface 122 of the cap plate 120.

As described above, the protective circuit module 200 is disposed in the recessed region 101 of the case 100 so that space efficiency of the rechargeable battery can be maximized and the protective circuit module 200 can be disposed without increasing the overall size of the rechargeable battery.

Thus, a rechargeable battery having a small size, a slim shape and an improved energy density can be provided.

It should be understood that the exemplary embodiments described herein should be considered in a descriptive sense only and not for purposes of limitation. Descriptions of features or aspects within each embodiment should typically be considered as available for other similar features or aspects in other embodiments.

While the disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery comprising:
an electrode assembly comprising a first electrode plate having a first polarity, a second electrode plate having a second polarity, and a separator interposed between the first and second electrode plates;
a can having an opening and housing the electrode assembly;
a cap plate substantially sealing the opening of the can,
wherein the cap plate has a substantially step shape that includes a higher region and a lower region; a protective circuit module placed over the cap plate; and
an electrode terminal formed over the cap plate.

2. The rechargeable battery of claim 1, wherein the electrode terminal is placed in the lower region of the cap plate.

3. The rechargeable battery of claim 1, wherein the lower region of the cap plate has first and second ends opposing each other, wherein the first end is closer to the higher region of the cap plate than the second end, and wherein the electrode terminal is placed on an area adjacent to the first end of the lower region.

4. The rechargeable battery of claim 1, wherein the lower region of the cap plate has first and second ends opposing each other, wherein the first end is closer to the higher region of the cap plate than the second end, and wherein the electrode terminal is placed on an area adjacent to the second end of the lower region.

5. The rechargeable battery of claim 1, wherein the protective circuit module is placed in the lower region.

6. The rechargeable battery of claim 5, wherein the protective circuit module comprises a first lead plate and a second lead plate electrically connecting the protective circuit module to the electrode terminal and the cap plate, wherein the lower region of the cap plate has first and second ends opposing each other, wherein the first end is closer to the higher region of the cap plate than the second end, wherein the first lead plate is electrically connected to the electrode terminal and wherein the second lead plate is electrically connected to the second end of the lower region of the cap plate.

7. The rechargeable battery of claim 1, wherein the electrode assembly includes a top portion adjacent to the opening of the can and wherein the top portion of the electrode assembly has a step shape substantially similar to the step shape of the cap plate.

8. The rechargeable battery of claim 1, wherein the electrode assembly comprises a first electrode tab and a second electrode tab, wherein the first electrode plate is electrically coupled to the electrode terminal via the first electrode tab, and wherein the second electrode plate is electrically coupled to the cap plate via the second electrode tab.

9. The rechargeable battery of claim 1, wherein the higher region and the lower region of the cap plate are connected via a coupling portion, and wherein the height of the protective circuit module is substantially equal to or less than the height of the coupling portion.

10. The rechargeable battery of claim 1, wherein the can comprises a bottom surface and a plurality of side surfaces that are substantially perpendicular to the bottom surface, wherein lower portions of the side surfaces are connected to the bottom surface and upper portions of the side surfaces form the opening, and wherein the cap plate i) is attached to the upper portions of the side surfaces and ii) comprises a lower surface forming the lower region and a higher surface forming the higher region.

11. A rechargeable battery comprising:
an electrode assembly comprising a first electrode plate having a first polarity, a second electrode plate having a second polarity, and a separator interposed between the first and second electrode plates;
a case housing the electrode assembly, wherein an external surface of the case has a substantially step shape that includes a higher region and a lower region;
a protective circuit module placed over the external surface of the case; and
an electrode terminal formed over the external surface of the case.

12. The rechargeable battery of claim 11, wherein the electrode terminal is placed in the lower region.

13. The rechargeable battery of claim 12, wherein the lower region has first and second ends opposing each other, and wherein the first end is closer to the higher region than the second end, wherein the protective circuit module comprises a first lead plate and a second lead plate formed at opposing ends thereof, wherein the first lead plate is configured to electrically connect the protective circuit module to the electrode terminal, and wherein the second lead plate is configured to electrically connect the protective circuit module to the second end.

14. The rechargeable battery of claim 11, wherein the protective circuit module is placed in the lower region.

15. The rechargeable battery of claim 11, wherein the electrode assembly includes a top portion adjacent to the external surface of the case and wherein the top portion of the electrode assembly has a step shape substantially similar to the step shape of the case.

16. The rechargeable battery of claim 11, wherein the height of the protective circuit module is substantially equal to or less than the difference in height between the higher and lower regions of the external surface.

17. A rechargeable battery, comprising:
an electrode assembly;
a can having an opening and housing the electrode assembly; and
a cap plate covering the opening of the can, wherein the cap plate has a substantially step shape that includes a higher region and a lower region.

18. The rechargeable battery of claim 17, wherein the electrode assembly includes a top portion adjacent to the opening of the can and wherein the top portion of the electrode assembly has a step shape substantially similar to the step shape of the cap plate.

19. The rechargeable battery of claim 17, further comprising an electrode terminal formed over the lower region of the cap plate, wherein the lower region of the cap plate has first and second ends opposing each other, wherein the first end is closer to the higher region of the cap plate than the second end, and wherein the electrode terminal is placed on an area adjacent to the first end of the lower region.

20. The rechargeable battery of claim 17, further comprising a protective circuit module formed over the lower region of the cap plate, wherein the height of the protective circuit module is substantially equal to or less than the difference in height between the higher and lower regions of the cap plate.
